(19) United States
(12) Patent Application Publication
(10) Pub. No.: US 2005/0008784 A1
(43) Pub. Date: Jan. 13, 2005

(54) Removal and replacement of antisoiling coatings

(75) Inventors: Steven J. Martin, Shoreview, MN (US); Mark J. Pellerite, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/607,717

(22) Filed: Jun. 27, 2003

(51) Int. Cl. B05D 3/02

(52) U.S. Cl. 427/393.4; 427/140; 427/162

(57) ABSTRACT

A method is described for removing and replacing an antisoiling coating on an article that includes an optical substrate, an antireflective coating, and a previously applied, silicon containing, antisoiling coating. The article is treated in a plasma to remove the previously applied antisoiling coating. A new antisoiling coating is applied that includes a fluorinated siloxane.

### FIELD OF THE INVENTION

The invention relates to a method for removal and replacement of antisoiling coatings on articles.

### BACKGROUND

Glare or the reflection of light can impair the transparency of optical substrates such as glass or plastic. Such optical substrates can be included, for example, in doors, windows, picture frames, optical lenses, filters, display devices (e.g., display panels of electronic devices), and the like. To remove or reduce the amount of glare, an antireflective coating can be applied to the surface of the optical substrate.

Glass surfaces typically have about 4 percent surface reflection. Plastic surfaces typically have about 10 percent surface reflection. With antireflective coatings, the surface reflection of glass and plastic can be reduced to less than about 0.5 percent and less than about 1 percent respectively in the visible region of the electromagnetic spectrum. The antireflective coatings typically contain one or more layers of dielectric materials. For example, antireflective coatings for use in the visible region can have multiple layers of alternating high and low index of refraction dielectric materials. The multiple layers can be arranged to cause constructive or destructive interference of various wavelengths of light. The thickness of the layers can be selected to provide an optical thickness that is equal to one-fourth or one-half the wavelength of the light (i.e., the thickness is typically less than one micrometer).

The layer or layers of the antireflective coating can be prepared by vacuum deposition (e.g., vacuum sputtering) of thin films containing dielectric materials such as metal oxides, metal fluorides, metal nitrides, or metal sulfides onto an optical substrate. These thin films prepared by vacuum deposition typically include clusters of particles forming a relatively rough profile, which helps reduce glare and reflection. The optical properties can be controlled by the choice of materials and the thickness of the individual layers.

High performance antireflective coatings prepared by vacuum deposition typically are porous and have high surface energies. The high surface energy tends to make the coatings prone to contamination by organic impurities (e.g., from sources such as fingerprints). Surface contaminants can result in degradation of the antireflective properties of the antireflective coating and can be quite noticeable to the end-user.

The surface of the antireflective coatings can be difficult to clean. In some instances, cleaning can detrimentally affect the antireflective properties by leaving a residue. To facilitate cleaning and allow the use of cleaning methods that leave little residue, an antisoiling coating is typically applied over the antireflective coating. The antisoiling coating provides an outer coating that can be more resistant to contamination and more easily cleaned than the antireflective coating.

The antisoiling coatings are typically prepared from silane or siloxane functional precursors. At times, the antisoiling coatings may need to be removed and replaced. For example, in some instances, a previously applied antisoiling coating can become defective or at least partially removed due to abrasion during the use of the article to which the coating has been applied.

### SUMMARY

The invention provides a method for removing and replacing an antisoiling coating on articles that include an optical substrate, an antireflective coating disposed on the optical substrate, and a previously applied, silicon containing, antisoiling coating disposed on at least a portion of the antireflective coating. The previously applied antisoiling layer can be removed and replaced with a new antisoiling coating without damaging the antireflective coating or the optical substrate.

The method involves treating the article in a plasma under vacuum conditions to remove the previously applied, silicon containing, antisoiling coating and then disposing a new antisoiling coating on the antireflective coating of the article. The new antisoiling coatings are typically fluorinated siloxanes.

In some embodiments, the method can be used to remove and replace silicon containing antisoiling coatings on an optical lens. For example, the method can be used during the process of preparing a prescription ophthalmic lens.

The above summary of the present invention is not intended to describe each disclosed embodiment or every implementation of the present invention. The Figures and the detailed description that follow more particularly exemplify these embodiments.

### BRIEF DESCRIPTION OF DRAWINGS

The invention may be more completely understood in consideration of the following detailed description of various embodiments of the invention in connection with the accompanying drawings, in which:

FIG. 1a is a schematic side view of an article having a previously applied antisoiling coating;

FIG. 1b is a schematic side view of a plasma treated article;

FIG. 1c is a schematic side view of a rejuvenated article having a new antisoiling coating;

FIG. 1d is a schematic side view of another rejuvenated article having a new antisoiling coating;

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The invention provides a method for replacing an antisoiling coating on articles that include an optical substrate, an antireflective coating disposed on the optical substrate, and a previously applied, silicon containing, antisoiling coating that is disposed on at least a portion of the antireflective coating. More particularly, the invention provides a method for removing and replacing the antisoiling coating on an optical lens such as an ophthalmic lens.

As used herein, the terms “a”, “an”, and “the” are used interchangeably with “at least one” to mean one or more of the elements being described.

As used herein, the term “optical substrate” refers to a substrate that can transmit light in at least a region of the electromagnetic spectrum. The optical substrate can be clear, colored, or opaque. In some embodiments, the optical substrate can transmit visible wavelengths of light (i.e., wavelengths of light in the range of about 400 nm to about 750 nm).

Suitable materials for optical substrates include, but are not limited to, glass, quartz, and polymeric materials. The optical substrate can be a laminate of two or more materials such as thermoplastic materials with or without an adhesive layer between the different materials.

Polymeric optical substrates can be prepared, for example, from polyacrylate, polymethacrylate, polymethyl methacrylate, polystyrene, styrene copolymers (e.g., acrylonitrile-butadiene-styrene copolymers and acrylonitrile-styrene copolymers), cellulose esters (e.g., cellulose acetate and cellulose acetate-butyrate copolymers), polyvinyl chloride, polyolefins (e.g., polyethylene and polypropylene), polycarbonate, polyimide, polyphenylene oxide, polyesters (e.g., polyethylene terephthalate and polyethylene naphthalate), or combinations thereof.

The optical substrate can have a primed surface. As used herein, a “primed surface” refers to a primer applied to a surface of the optical substrate or to a surface of the optical substrate that has been treated to function as a primer. A primed surface, at least in some instances, can increase adhesion of the antireflective coating to the optical substrate. The primer can be an acrylic layer or another adhesion promoting layer applied to the surface or the optical substrate. Suitable adhesion promoting layers are described in International Patent Application WO 99/38034, incorporated herein by reference in its entirety. The thickness of the adhesion promoting layer is typically in the range of about 50 micrometers or less, about 25 micrometers or less, about 10 micrometers or less, about 5 micrometers or less, about 4 micrometers or less, or about 2 micrometers or less. Alternatively, the primed surface of the optical substrate can result from chemical etching, electron beam irradiation, corona treatment, plasma etching, or the like.

As used herein, the term “antireflective” coating refers to at least one layer of a dielectric material having an index of refraction that is lower than the index of refraction of the material underneath the coating (e.g., the optical substrate). The antireflective coating layer is disposed on at least one major surface of the optical substrate. The antireflective coating can transmit light in a region of the electromagnetic spectrum (e.g., wavelengths transmitted by the optical substrate). For example, the antireflective coating can transmit visible wavelengths of light. In some embodiments, the antireflective coating is in the form of an antireflective stack that includes multiple layers of dielectric materials. For example, a stack can contain up to about 11, up to about 9, up to about 7, up to about 5, or up to about 3 antireflective coating layers.

The antireflective coating layers can be prepared from dielectric materials such as metal oxides, metal sulfides (e.g., zinc sulfide), metal halides (e.g., magnesium fluoride), metal nitrides (e.g., nitrides of silicon, titanium, zinc, zirconium, hafnium, vanadium, and niobium), or combinations thereof.

In some embodiments, the antireflective coating layers are prepared from metal oxides. As used herein, the term “metal oxide” refers to an oxide of a single metal (including metalloids) or to an oxide of a metal alloy. Suitable metal oxides for one or more layers of an antireflective coating include oxides of tin, titanium, niobium, zinc, zirconium, tantalum, yttrium, aluminum, cerium, tungsten, bismuth, indium, silicon, and mixtures thereof. Specific examples include SnO₂, TiO₂, Nb₂O₅, ZnO, ZrO₂, Ta₂O₅, Y₂O₃, Al₂O₃, CeO₂, WO₃, Bi₂O₅, In₂O₃, and ITO (indium tin oxide). In some embodiments, the antireflective coating can be a single layer of silicon oxides or can include an outer layer of silicon oxides. The silicon oxides can be depleted of oxygen (i.e., the amount of oxygen in the metal oxide is less than the stoichometric amount). For example, the outer surface can include SiOX where x is no greater than two.

Antireflective coatings can be deposited by thermal evaporation, sputtering techniques, or other vacuum deposition methods. In some applications, metal oxide films formed by sputtering techniques are preferred over metal oxide films formed by thermal evaporation techniques. Sputter coated antireflective coatings tend to have higher densities and to be harder, smoother, and more durable than thermally evaporated coatings. Although such sputtered coatings tend to be relatively porous and consist of clusters of particles with diameters of about 5 to about 30 nanometers as measured by atomic force microscopy, the coatings are usually sufficiently impermeable to water and gases that can alter their mechanical, electrical, and optical properties.

Suitable multilayer coatings are exemplified in International Publication No. WO 96/31343 (Southwall Technologies Inc.); U.S. Pat. No. 5,091,244 (Bjornard); U.S. Pat. No. 5,105,310 (Dickey); U.S. Pat. No. 5,147,125 (Austin); U.S. Pat. No. 5,270,858 (Dickey); U.S. Pat. No. 5,372,874 (Dickey et al.); U.S. Pat. No. 5,407,733 (Dickey); U.S. Pat. No. 5,450,238 (Bjornard et al.), and U.S. Pat. No. 5,579,162 (Bjornard et al.), all of which are incorporated herein by references in their entireties. Antireflective coatings can also be applied as a film stack. Such film stacks are commercially available, for example, from Viratec Thin Films, Inc., Faribault, Minn.

As used herein, the term “antisoiling” coating refers to a coating having a static water contact angle of at least about 80 degrees. Such coatings are hydrophobic. The coatings can also be oleophobic. The antisoiling coating tends to render a surface more resistant to contamination from grease or oils such as skin oils arising from fingerprints. Antisoiling coatings also tend to render the surface easier to clean using water or dry wiping. The coatings typically contain or are derived from a silicon containing compound such as a silane or a siloxane. In some embodiments, the antisoiling coatings can include a fluorinated siloxane layer (i.e., a fluorine-containing organopolysiloxane having Si—O—Si bonds). Suitable fluorinated siloxanes include, but are not limited to, fluorinated alkylsiloxane, fluorinated dialkylsiloxane, and perfluoropolyether siloxanes.

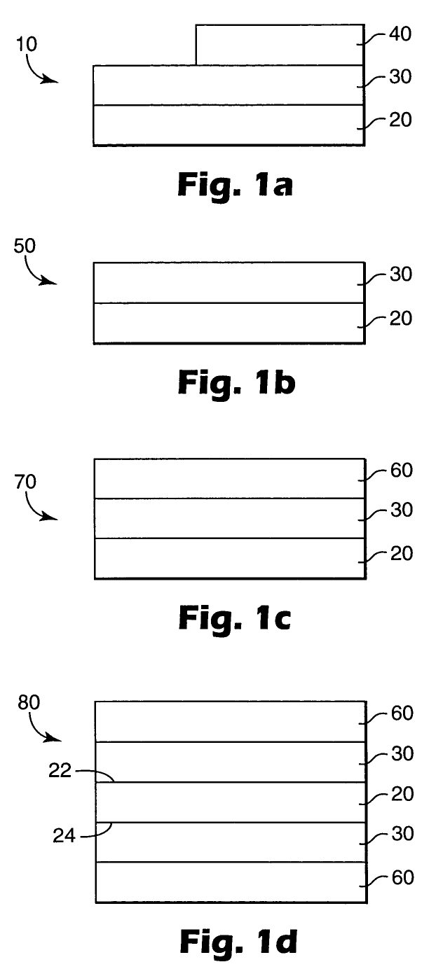

One aspect of the invention provides a method of replacing a previously applied, silicon containing, antisoiling coating on an article. A typical article is exemplified in FIG. 1a. The layers in FIG. 1a and the other figures are not drawn to scale. The article 10 includes an optical substrate 20, an antireflective coating 30 disposed on a surface of the optical substrate 20, and a previously applied, silicon containing, antisoiling coating 40 disposed on at least a portion of the antireflective coating 30. The antireflective coating 30 is between the optical substrate 20 and the antisoiling coating 40. The article 10 is treated with a plasma under vacuum conditions to remove the previously applied antisoiling coating 40. The plasma treated article 50, exemplified in FIG. 1b, includes the optical substrate 20 and the antireflective coating 30. Other coatings such as, for example, scratch resistant coatings can be present between the optical substrate 20 and the antireflective coating 30. A new antisoiling coating 60 is disposed on the antireflective coating 30 of the plasma treated article 50. The rejuvenated article 70 is exemplified in FIG. 1c. A new antisoiling coating 60 can be disposed on the antireflective coating 30. The antireflective coating 30 is positioned between the optical substrate 20 and the new antisoiling layer 60.

As exemplified in FIG. 1d, the article 80 can include an antireflective coating 30 on a first major surface 22 and a second major surface 24 of an optical substrate 20. The article can further include an antisoiling coating 60 on each antireflective coating 30.

In some embodiments, the article is an optical lens. The optical lens, for example, can be used in corrective eyewear, sunglasses, photographic equipment, microscopic equipment, telescopic equipment, binoculars, magnifying lenses, and the like. In a specific example, the optical lens can be an ophthalmic lens.

As used herein, an ophthalmic lens refers to an optical lens for corrective eyewear. The ophthalmic lens typically includes an optical substrate (i.e., base lens) prepared from polycarbonate or another polymeric material. The ophthalmic lens can also include scratch resistant, antireflective, and antisoiling coatings.

The antireflective characteristics of ophthalmic lenses can be imparted by deposition of multiple layers of vacuum deposited metal oxides on the base lens. The outermost layer of the antireflective coating is typically a silicon oxide. The antireflective coating is typically protected by deposition of a hydrophobic, antisoiling coating. Such antisoiling coatings are typically vapor deposited from a low molecular weight alkysilane such as octylsilanes or perfluorooctylethylsilanes. These vapor deposited antisoiling coatings can be effective in sealing the surface of the ophthalmic lens and providing some antisoiling properties without interfering with the function of the antireflective coatings. However, the durability of some of these antisoiling coatings to dry rub abrasion can be relatively poor. Further, the oil repellency of some of the vapor deposited antisoiling coatings may be less than desired.

The methods of the invention can be used to replace defective antisoiling coatings that were previously applied to an ophthalmic lens. That is, a previously applied antisoiling coating can be removed and the lens can be reconditioned by application of a new antisoiling coating. The methods can also be used in the preparation of prescription ophthalmic lenses.

Prescription ophthalmic lenses are typically prepared from standard ophthalmic lenses. The standard lenses can include, but are not limited to, an optical substrate, an antireflective coating, and an antisoiling coating. Both major surfaces of the optical substrate can be coated with the antireflective coating and the antisoiling coating such that the antireflective coating is positioned between a major surface of the optical substrate and the antisoiling coating.

To prepare a prescription ophthalmic lens, a portion of a standard lens is ground away. The grinding step can remove part of the optical substrate, part of the antireflective coating, and part of the antisoiling coating. After grinding, the removed antireflective coating and removed antisoiling coating can be replaced. This invention relates to replacement of the antisoiling coating. The invention provides a method to remove any remaining portion of the previously applied antisoiling coating before a new coating is applied.

The article having a previously applied antisoiling coating can be placed in a chamber under vacuum. The vacuum is typically in the range of about 0.01 to 1 mm Hg or in the range of about 0.05 to about 0.5 mm Hg. A plasma is generated in the chamber using argon, nitrogen, xenon, air, oxygen, water, or a combination thereof. The radio frequency (i.e., RF) power used to generate the plasma is typically less than about 30 watts. For example, the RF power can be in the range of about 6 to about 20 watts. The power to the RF coil is typically in the range of about 0.01 to about 0.10 watts/cm². In some plasma systems the power to the RF coil is 0.05 watts/cm².

In some applications, the plasma is generated using air. The article can be placed, for example, in a vacuum chamber. The residual air in the vacuum chamber can be at a concentration sufficient to generate a plasma. When residual air in the vacuum chamber is used, no external gas supply is needed to generate the plasma. However, an air plasma can also be generated using compressed air. Compressed air can be introduced into the vacuum chamber to maintain the pressure in the range of about 0.05 to about 0.5 mm Hg. The air can be purified, dried, or a combination thereof.

The plasma treatment can remove the previously applied, silicon containing, antisoiling coating from the article. Such coatings typically have a static water contact angle of at least about 80 degrees. The previously applied antisoiling coatings cannot be removed with washing. For example, the previously applied coating cannot be removed by washing with water, a detergent solution, or an alcohol containing solution.

In some embodiments, the previously applied antisoiling coatings are hydrocarbon siloxanes or fluorinated siloxanes. Fluorinated siloxanes include, but are not limited to, fluorinated alkylsiloxanes, fluorinated dialkylsiloxanes, and fluorinated polyethersiloxanes. The previously applied coatings can be covalently bonded to the antireflective coating. For example, there can be a bond such as a M—O—Si bond (i.e., M is a metal in the dielectric material included in the antireflective coating) between the antireflective coating and the previously applied antisoiling compound.

The plasma typically oxidizes and volatilizes organic constituents on the outer surfaces of the article. The organic constituents from all exposed surfaces of the article can be removed. For example, the treatment can remove the previously applied antisoiling layer and any trace contamination such as skin oils or grease that may be present on the article. The plasma treatment can break covalent bonds while decomposing the previously applied antisoiling coating. For example, the plasma can break covalent bonds between the previously applied antisoiling coating and the antireflective coating.

The plasma treatment typically removes less than about 500 Å of material, less than about 300 Å of material, less than about 200 Å of material, or less than about 100 Å of material from the article. The material removed includes the previously applied antisoiling coating. The time needed to effectively remove the previously applied antisoiling coating is dependent on such variables as the thickness of the coating, the RF power, the vacuum, the plasma composition, and the size of the article. Typically, the time needed to remove the previously applied antisoiling coating is less than about 10 minutes, less than about 5 minutes, less than about 3 minutes, or less than about 1 minute in an air plasma. In some applications, the treatment time is in the range of about 1 to about 3 minutes.

The antireflective coating and the optical substrate remain intact after the plasma treatment. That is, the antireflective coating and the optical substrate are not etched, oxidized, or removed by the plasma treatment. The antireflective coating is typically an inorganic material such as a metal oxide that is not decomposed by the plasma treatment. If the optical substrate is a polymeric material, it can be protected from decomposition in the plasma by the presence of the inorganic antireflective coating. Masks made of an inorganic material such as an inorganic dielectric material can be used can also be used to protect parts of the article that contain exposed organic material. The treated articles in some applications have an outer surface of silicon oxides corresponding to the outer layer of the antireflective coating.

Removal of the topcoat can be monitored by a surface analysis technique such as time-of-flight secondary-ion mass spectrometry (TOF/SIMS). This analytical technique can be used to demonstrate that substantial removal of the antisoiling coating and exposure of the antireflective coating has occurred. For instance, TOF/SIMS analysis of an ophthalmic lens having both an antireflective and a previously applied fluorinated antisoiling coating has a positive ion spectrum with peaks corresponding to fluorocarbon fragments such as CF⁺, CF₃⁺, and C₂F₅⁺. Analysis of the same ophthalmic lens after exposure to a plasma treatment for a time sufficient to remove the antisoiling coating can be used to confirm the disappearance of these fluorocarbon fragments and the appearance of fragments associated with the uppermost layer of the antireflective coating.

The process for replacing an antisoiling coating can further include washing the article, placing the article in an ultrasonic bath, chemically treating the article, or a combination thereof. This optional step can be used, for example, to remove any salt, oil, or grease from the surface of the article. The article can be washed or treated in an ultrasonic bath with water, a detergent solution, a dilute acid solution, a dilute basic solution, an organic solvent such as alcohol and alcohol/chloroform, or a combination thereof. Such a washing step can, at least in some embodiments, reduce the time needed to prepare a surface that is free of the previously applied antisoiling coating and contaminants.

For example, the article can be cleaned with a detergent solution prior to the plasma treatment. The washing solution can vary in temperature from about 20° C. to about 70° C. Examples of suitable detergents include, but are not limited to, Alconox from Alconox, Inc., New York, N.Y. and RBS-PF concentrate available from Pierce Chemical, Rockford, Ill. and Fluka Chemical Corp., Milwaukee, Wis. The detergent solution typically contains about 0.001 to about 2 weight percent detergent based on the weight of the solution. When washing by hand, for example, the detergent concentration can be in the range of about 0.5 to about 2 weight percent. When washing in a automatic washing device, for example, the detergent concentration can be in the range of about 0.001 to about 0.2 weight percent.

In some embodiments, the surface of the plasma treated article is acid activated. Suitable acids include, but are not limited to, hydrochloric acid, sulfuric acid, phosphoric acid, hydrobromic acid, nitric acid, acetic acid, trifluoroacetic acid, and organic acid such as tartaric acid or citric acid. Acid activation is further described in U.S. Pat. No. 5,707,740, the disclosure of which is hereby incorporated by reference.

After removal of the previously applied antisoiling coating, a new antisoiling coating is disposed on the outer surface of the treated article (i.e., on at least one major surface of the antireflective coating). The new antisoiling coating can be oleophobic, hydrophobic, or a combination thereof. As used herein, the term “hydrophobic” refers to a surface that has a static water contact angle of at least about 80 degrees. As used herein, the term “oleophobic” refers to a surface that has a static hexadecane contact angle of at least about 40 degrees. In some applications, the antisoiling coating can be a fluorinated siloxane film such as a fluorinated alkylsiloxane, fluorinated dialkylsiloxane, fluorinated polyethersiloxane, or a combination thereof. The method of measuring contact angle is described further in the example section.

Some fluorinated siloxane coatings can be prepared by self-assembly. As used herein, the term “self-assembly” refers to the spontaneous adsorption and film formation of the active coating ingredient on the antireflective coating surface. The antisoiling coating can include a monolayer base film that is covalently bonded to the antireflective coating.

The overall thickness of the new antisoiling coating is typically at least 15 Å thick or the approximate thickness of a monolayer of the fluorinated siloxane. In some applications, the new antisoiling coating has a thickness less than about 30 Å, less than about 50 Å, less than about 100 Å, less than 150 Å, less than about 200 Å, or less than about 500 Å. The thickness is generally selected so that the antireflective characteristics of the article are not adversely affected. For example, when the antisoiling coating is applied to only a portion of the antireflective coating of the treated article, the boundary between coated and uncoated areas is typically only barely discernible to the naked eye. To adequately balance performance with respect to antisoiling, durability, and antireflectance, the thickness of the antisoiling layer in some applications is in the range of about 40 Å to about 150 Å.

The antisoiling coating can be applied to the treated article by a variety of techniques. Suitable application techniques include, but are not limited to, spraying, casting, rolling, or immersing. With some application techniques, an antisoiling coating composition is prepared. The coating composition can be applied to all surfaces, selected surfaces, or portions of selected surfaces of the treated article.

The antisoiling coating composition typically contains an inert solvent and a precursor of the fluorinated siloxane. As used herein, the term “precursor” refers to a fluorinated silane or fluorinated siloxane that cures by hydrolysis and condensation to form the fluorinated siloxane antisoiling coatings. The coating compositions typically contain less than about 2 weight percent, less than about 1 weight percent, less than about 0.5 weight percent, or less than about 0.3 weight percent of the precursor based on the weight of the coating composition.

In some embodiments, the treated article can be immersed into the coating composition. For example, the treated article can be immersed at room temperature (i.e., about 20° C. to about 25° C.) for less than about 10 minutes. For some applications, the immersion time can be less than about 5 minutes, less than about 3 minutes, or less than about 1 minute. The immersion time can depend on the concentration of the antisoiling composition. For example, at a coating concentration of about 0.1 weight percent precursor, the rate of withdrawal can be about 0.1 cm/sec to about 2.5 cm/sec or about 0.5 to about 1.5 cm/sec.

Suitable precursors for fluorinated siloxanes include compounds of formula I:
R_{f}R¹—SiY₃₋ₓR²ₓ]ₙ
R_{f} is a perfluorinated group that optionally contains one or more heteroatoms (e.g., oxygen atoms). For example, R_{f} can be a perfluoroalkyl or perfluoropolyether. R_{f} can be linear or branched and can be monovalent or divalent. R¹ is a connecting group and includes a divalent alkylene, arylene, or mixture thereof, which can be substituted with one or more heteroatoms (e.g., nitrogen, oxygen, or sulfur) or functional groups (e.g., halogen, carbonyl, amido, or sulfonamido). The heteroatom can be caternary. R¹ contains about 2 to about 16 or about 3 to about 10 carbon atoms. R² is a lower alkyl group such as a C₁₋₄ alkyl. In some embodiments, R² is a methyl group. Y is a halogen, a lower alkoxy group (i.e., a C₁₋₄ alkoxy such as ethoxy or methoxy), or an acyloxy group (e.g., —OC(O)R³ where R³ is a C₁₋₄ alkyl group). The variable x is equal to 0 or 1 and n is equal to 1 or 2. The compounds of formula I typically have a molecular weight (number average) of at least about 400, at least about 500, at least about 750, or at least about 1000. These precursors are described further in U.S. Pat. Nos. 5,851,674 and 6,277,485, incorporated herein by reference in their entireties.

Examples of fluorinated silanes of formula I where n is equal to 1 include, but are not limited to, C₇F₁₅CH₂OCH₂CH₂CH₂SiCl₃, C₇F₁₅CH₂OCH₂CH₂CH₂Si(CH₃)Cl₂, C₇F₁₅CH₂OCH₂CH₂CH₂SiCl(OCH₃)₂, C₇F₁₅CH₂OCH₂CH₂CH₂SiCl₂(OC₂H₅), C₃F₁₇SO₂N(C₂H₅)CH₂CH₂CH₂SiCl₃, C₈F₁₇SO₂N(CH₃)CH₂CH₂CH₂Si(CH₃)Cl₂, C₇F₁₅CH₂OCH₂CH₂CH₂Si(OAc)₃, C₃F₇O(CF(CF₃)CF₂O)ₚCF(CF₃)CONH(CH₂)₃Si(OCH₃)₃, C₃F₇O(CF(CF₃)CF₂O)ₚCF(CF₃)CONH(CH₂)₃Si(OC₂H₅)₃, C₃F₇O(CF(CF₃)CF₂O)ₚCF(CF₃)CONH(CH₂)₃SiCH₃(OCH₃)₂, C₃F₇O(CF(CF₃)CF₂O)ₚCF(CF₃)CONH(CH₂)₃SiCH₃(OC₂H₅)₂, CF₃O(C₂F₄O)ₚCF₂CONH(CH₂)₃Si(OCH₃)₃, CF₃O(C₂F₄O)ₚCF₂CONH(CH₂)₃Si(OC₂H₅)₃, CF₃O(C₂F₄O)ₚCF₂CONH(CH₂)₃SiCH₃(OCH₃)₂₁ and CF₃O(C₂F₄O)ₚCF₂CONH(CH₂)₃SiCH₃(OC₂H₅)₂ where p is in the range of about 4 to about 40.

Examples of fluorinated silanes of formula I where n is equal to 2 include, but are not limited to, X—CF₂O(CF₂)ₘ(C₂F₄O)_{q}CF₂—X, X—CF(CF₃)(OCF₂CF(CF₃))ₘO(CₙF₂ₙ)O(CF(CF₃)CF₂O)_{q}CF(CF₃)—X, X—CF₂O(C₂F₄O)_{q}CF₂—X, and X—(CF₂)₃O(C₄F₈O)_{q}(CF₂)₃—X where m is an integer of 0 to about 50, n is an integer of 2 to 4, q is an integer of 0 to about 50, wherein both m and q are not equal to 0. X is selected from —CONH(CH₂)₃Si(OCH₃)₃, —CONH(CH₂)₃Si(OC₂H₅)₃, —CONH(CH₂)₃SiCH₃(OCH₃)₂, —CONH(CH₂)₃SiCH₃(OC₂H₅)₂, and a combination thereof.

In some applications, the fluorinated silane precursor is a compound of formula X-CF₂O(CF₂)ₘ(C₂F₄O)_{q}CF₂—X where m an q are independently equal to about 5 to about 15 or about 8 to about 12 or about 9 to about 10. X is selected from —CONH(CH₂)₃Si(OCH₃)₃, —CONH(CH₂)₃Si(OC₂H₅)₃, —CONH(CH₂)₃SiCH₃(OCH₃)₂, —CONH(CH₂)₃SiCH₃(OC₂H₅)₂, and a combination thereof. For example, the fluorinated silane precursor can be (H₃CO)₃Si(CH₂)₃NHCOCF₂O(CF₂O)ₘ(C₂F₄O)_{q}CF₂CONH(CH₂)₃Si(OCH₃)₃ where both m and q are equal to about 8 to about 12 or about 9 to about 10.

The compound of formula I can undergo reaction with the materials in the antireflective coating layer. For example, covalent bonds can be formed with metal oxides on an outer surface of the antireflective coating layer. For formation of a durable antisoiling coating, sufficient water should be present to hydrolyze the silane end groups. The resulting silanol group can undergo condensation reactions to form Si—O—Si bonds and M—O—Si bonds where M represents a metal of the antireflective coating. That is, the antisoiling coating can be covalently bonded to metal atoms in the antireflective coating.

The water needed for reactivity of the fluorinated silane or fluorinated siloxane precursors can be present in the coating composition or adsorbed to the surface of the antireflective coating layer. Typically, sufficient water is present for the preparation of a durable coating if the coating method is carried out at room temperature in an atmosphere having a relative humidity of about 30% to about 50%.

Suitable solvents are substantially inert (i.e., substantially inert with the fluorinated silane or siloxane), aprotic, and capable of dissolving the fluorinated silane or siloxane precursor. Examples of suitable solvents include, but are not limited to, hydrocarbons (e.g., alkanes such as heptane, decane, or paraffinic solvents), fluorinated hydrocarbons (e.g., fluorine substituted alkanes, fluorine substituted ethers, and alkyl perfluoroalkyl ethers), hydrochlorofluoro alkanes and ethers, and mixtures thereof.

In some embodiments, the solvents are hydrofluoroethers such as alkyl perfluoroalkyl ethers. Suitable hydrofluoroethers are described in U.S. Pat. No. 6,274,543 B1, the disclosure of which is incorporated herein by reference. For example, the alkyl perfluoroalkyl ether can be methyl perfluorobutylether (e.g., 3M Novec Engineered Fluid HFE-7100 available from 3M, St. Paul, Minn.), ethyl perfluorobutyl ether (e.g., 3M Novec Engineered Fluid HFE-7200 available from 3M, St. Paul, Minn.), or combinations thereof.

The antisoiling composition containing the fluorinated silane or fluorinated siloxane precursor and the desired solvent system may also contain various additives. Exemplary additives include cure catalysts (e.g., dibutyltin diacetate) and other silanes (e.g., tetraethylorthosilicate). Typically, additives are selected that do not react with the fluorinated silane or fluorinated siloxane precursors.

In another embodiment, the antisoiling coating is applied by wiping the plasma treated article with a woven or nonwoven fabric that contains the antisoiling coating composition. The fluorinated silane or fluorinated siloxane precursor can be transferred from the fabric to the treated surface.

Typically, after an antisoiling coating composition is applied to the antireflective coating of the article, the solvent, if present, is allowed to evaporate or flash off and the dried composition is allowed to at least partially cure to impart durability to the antisoiling coating. The drying and curing can be carried out in one step or multiple steps. For example, the drying and curing can occur by allowing the coated article to stand in a humid environment (e.g., at room temperature and a relative humidity of about 30% to about 55%). Sufficient water is needed for the silane groups to hydrolyze and condense with each other and with the antireflective coating surface. Alternatively, the article can be heated to at least partially cure the coating. If thermal energy is used, temperatures are chosen that do not result in destruction of the article (e.g., at a temperature that does not melt the optical substrate). The temperature is typically at least about 50° C. or at least about 60° C. The temperature is no greater than the melting temperature of the optical substrate.

The antisoiling coating can be cured using electron beam radiation, infrared radiation, ultraviolet radiation, or visible radiation. Electron beam radiation suitable for curing the antisoiling coating can have an energy level of about 0.1 to about 10 megarad (Mrad) or about 1 to about 10 Mrad. Ultraviolet and visible light curing can be preferred for some applications because these radiation sources tend to cause little, if any, damage to polymeric optical substrates. The ultraviolet radiation can have a wavelength in the range of about 200 to 400 nm or in the range of about 250 to about 400 nm. Visible radiation refers to radiation having a wavelength in the range of about 400 to about 750 nm or of about 400 to about 550 nm.

For enhanced antisoiling performance, the antisoiling coating is allowed to at least partially cure. With fluorinated silanes, for example, a sufficient level of cure can be determined by the Ink Test as described in Example 1 of U.S. Pat. No. 5,382,639 (Moore et al.), incorporated herein by reference. Whether partially or totally cured, a suitable antisoiling coating is one that causes dewetting and beading of ink and that allows the ink to be easily removed by wiping with a dry cloth.

The method of the present invention can be used, for example, by retail lens shops to recondition ophthalmic lenses and to prepare new prescription ophthalmic lenses. All that is required is a commercially available plasma generator and a small vacuum pump to remove the previously applied coating. Further, environmental hazards associated with the use of harsh chemical stripping solutions such as hydrofluoric acid or chromic acid can be avoided.

Further, sophisticated and expensive vacuum equipment is not needed to form the antisoiling coatings on the antireflective coatings. Rather, antisoiling coatings based on the precursors of formula I can be applied using an immersion method. The antisoiling coating compositions can be prepared from solvents that can be recycled or recovered. The generation of hazardous waste is minimal.

The invention is further described by the following examples, which are provided for illustration only and are not intended to be limiting in any way.

### EXAMPLES

### Example 1

Four finished ophthalmic lenses (Essilor Crizal™) were obtained from Maplewood Eye Care Center, Maplewood, Minn. Fingerprints were removed by dipping the lenses in isopropyl alcohol and then drying under a nitrogen stream. The lenses were tested for hydrophobicity by application of a few drops of Millipore-grade filtered water. All lenses showed water beading, indicating the presence of a hydrophobic coating.

The lenses were placed in a Harrick PDC-3xG plasma cleaner/sterilizer (available from Harrick Scientific Corp., Ossining, N.Y.) operated at 0.1-0.5 mm Hg for 15 min, then removed and retested with water droplets. All lenses showed spontaneous spreading of the water, indicating removal of the hydrophobic coating. The visual appearance of the lenses was identical to that of untreated lenses, showing that the plasma treatment did not alter the optical properties of the AR stack.

After another dip in isopropyl alcohol and drying under nitrogen, the lenses were put back in the plasma cleaner for another 5 min, then dip coated immediately in a freshly prepared solution of 0.1 wt % silane in HFE-7100. The silane was (H₃CO)₃Si(CH₂)₃NHCOCF₂O(CF₂O)ₘ(C₂F₄O)_{q}CF₂CONH(CH₂)₃Si(OCH₃)₃ where both m and q are equal to about 9 to about 10. An automated dip coater (Unislide™ Assemblies, Velmex Inc., Bloomfield, N.Y.) was used for the dipping, at a withdrawal speed of 3-4 mm/sec. The coated lenses were allowed to stand overnight in air at room temperature, then placed in a forced-air oven at 60° C. for 1 hr.

After cooling, the lenses were tested on both sides by application of water drops and blue permanent Sharpie™ marker ink. All surfaces exhibited beading of the ink into discrete droplets which were easily removed by dry wiping with a Kimwipe. Water beading was also excellent, and the drops ran off the surface leaving no trace when the lenses were tilted vertically.

### Example 2

Test lenses (Essilor Airwear Crizal™, and Gentex GLC with Zeiss AR and top coats) were obtained from Twin City Optical (Plymouth, Minn.). One lens of each type was used in this study. First, water and hexadecane contact angles were measured on the fresh lenses using a VCA-2500XE video contact angle apparatus (AST Products, Billerica, Mass.). One drop of Millipore-grade filtered water was applied to the center of the lens and measured, then this was removed, the surface blown dry, and then one drop of hexadecane was placed in the center of the lens. Static, advancing, and receding contact angles were determined for water, while advancing and receding angles were determined for hexadecane. Contact angles were measured on both sides of the drops, and the results averaged.

The lenses were dipped for a few seconds in an isopropyl alcohol ultrasound bath, then placed in a plasma cleaner (identical to the one used in Example 1) for 10 min. Hydrophilicity of the lens surfaces was then confirmed as described in Example 1, demonstrating that the commercial hydrophobic coatings were removed with no visible change in the lens AR properties.

After water was removed under a nitrogen stream, the lenses were put back in the plasma cleaner for another 2 min. They were then dip coated, using the methods and apparatus described in Example 1, in a fresh solution of 0.1 wt % silane (as in Example 1) in HFE-7100, and heated in an oven at 80° C. for 1 hr. Water and hexadecane contact angles were remeasured using the methods described above. The lenses were given another plasma treatment identical to that described above, again giving hydrophilic surfaces. The silane was then reapplied by dip coating in the same solution using the same techniques described above, and contact angles were remeasured. Results from the contact angle measurements are shown in Table 1 below. These results show that all three antisoiling coatings were removed by the plasma treatment.

TABLE 1
Contact Angles on AR Lenses After Various Treatments

| | | Water | Hexadecane |
|---|---|---|---|
| | Lens | Static/Advancing/Receding | Advancing/Receding |
| Treatment | Type | Contact Angle (°) | Contact Angle (°) |
| None | Crizal | 107/129/85 | 78/56 |
| | Zeiss | 108/116/102 | 30/23 |
| First Plasma | Crizal | ˜0 | — |
| Cleaning | | | |
| | Zeiss | ˜0 | — |
| Dip Coat w/ Silane 1 | Crizal | 105/113/91 | 64/56 |
| | Zeiss | 106/113/91 | 65/56 |
| Second Plasma | Crizal | ˜0 | — |
| Cleaning | | | |
| | Zeiss | ˜0 | — |
| Dip Coat w/ Silane 1 | Crizal | 104/109/74 | 64/52 |
| | Zeiss | 105/106/88 | 65/57 |

1. A method for replacing an antisoiling coating on an article, said method comprising:
providing an article comprising an optical substrate, an antireflective coating disposed on a surface of the optical substrate, and a previously applied antisoiling coating comprising silicon that is disposed on at least a portion of the antireflective coating, wherein the antireflective coating is between the optical substrate and the antisoiling coating;
treating the article with a plasma under vacuum conditions to remove the previously applied antisoiling coating from the antireflective coating; and
disposing a new antisoiling coating on the antireflective coating of the article.

2. The method of claim 1, wherein the pressure during said treating is in the range of 0.05 to 0.5 mm Hg.

3. The method of claim 1, wherein the plasma during said treating has a radio frequency power less than about 30 watts.

4. The method of claim 1, wherein said treating leaves the antireflective coating and the optical substrate intact.

5. The method of claim 1, wherein said treating removes less than 500 Å of the previously applied antisoiling coating from the article.

6. The method of claim 1, wherein said treating removes less than 100 Å of the previously applied antisoiling coating from the article.

7. The method of claim 1, further comprising washing the article, placing the article in an ultrasonic bath, chemically treating the article, or a combination thereof prior to said treating.

8. The method of claim 1, wherein the article is an optical lens.

9. The method of claim 1, wherein the article is an ophthalmic lens.

10. The method of claim 1, wherein the antireflective coating comprises a metal oxide, metal sulfide, metal halide, metal nitride, or combination thereof.

11. The method of claim 1, wherein the antireflective coating comprises at least one metal oxide layer.

12. The method of claim 11, wherein an outer layer of the antireflective coating comprises silicon oxides.

13. The method of claim 1, wherein the plasma is produced using argon, xenon, air, water, oxygen, or a combination thereof.

14. The method of claim 1, wherein the plasma is produced using air.

15. The method of claim 1, wherein the previously applied coating has a static water contact angle of at least 80 degrees.

16. The method of claim 1, wherein the previously applied antisoiling coating comprises a siloxane.

17. The method of claim 1, wherein the new antisoiling coating is hydrophobic, oleophobic, or a combination thereof.

18. The method of claim 1, wherein the new antisoiling coating comprises a fluorinated alkylsiloxane, fluorinated dialkylsiloxane, perfluoropolyether siloxane, or combination thereof.

19. The method of claim 1, wherein said disposing comprises:
providing a solution of a fluorinated silane or fluorinated siloxane precursor in an inert solvent;
immersing a plasma treated article into the solution.

20. The method of claim 19, wherein the inert solvent is an alkyl perfluoroalkyl ether.

21. The method of claim 19, wherein the fluorinated silane precursor comprises a compound having a molecular weight of at least about 400, said compound being of formula I:
R_{f}R¹—SiY₃₋ₓR²ₓ]ₙ
wherein
R_{f} is a fluorinated group that optionally contains one or more heteroatoms;
R¹ is a substituted divalent alkylene group, arylene group, or mixture thereof that optionally contains one or more heteroatoms, wherein at least one substituent comprises a heteroatom, a functional group, or a halogen;
R² is a C₁₋₄ alkyl;
Y is a halogen, a C₁₋₄ alkoxy, or a C₁₋₄ acyloxy group;
x is equal to 0 or 1; and
n is equal to 1 or 2.

22. The method of claim 19, wherein the fluorinated silane precursor comprises a perfluoropolyether of formula
XCF₂O(CF₂O)ₘ(C₂F₄O)ₙCF₂X
wherein
X is equal to —CONH—CH₂—CH₂—CH₂—Si(OCH₃)₃;
m is an integer of 8 to 11; and
n is an integer of 8 to 11.

23. The method of claim 1, wherein said disposing comprises:
placing a fluorinated silane or fluorinated siloxane precursor on a fabric;
transferring the fluorinated silane or fluorinated siloxane precursor from the fabric to a surface of a plasma treated article.

24. The method of claim 1, further comprising acid activating a surface of a plasma treated article prior to said disposing.

25. The method of claim 1, further comprising curing the new antisoiling coating.

26. A method for replacing an antisoiling coating on an article, said method comprising:
providing an article comprising a polymeric optical substrate comprising, an antireflective coating disposed on a surface of the polymeric optical substrate, and a previously applied antisoiling coating comprising silicon that is disposed on at least a portion of the antireflective coating, wherein the antireflective coating is between the polymeric optical substrate and the antisoiling coating;
treating the article with a plasma under vacuum conditions to remove the previously applied antisoiling coating from the antireflective coating; and disposing a new antisoiling coating on the antireflective coating of the article.
